(19) United States
(12) Patent Application Publication
(10) Pub. No.: US 2016/0035017 A1
(43) Pub. Date: Feb. 4, 2016

(54) MINI STORAGE SYSTEM USING DISTRIBUTED PEER STORAGE SPACE

(71) Applicant: Stephanie Yinman Chan, Saratoga, CA (US)

(72) Inventor: Stephanie Yinman Chan, Saratoga, CA (US)

(21) Appl. No.: 14/448,910

(22) Filed: Jul. 31, 2014

(51) Int. Cl. G06Q 30/06; G06F 17/30

(52) U.S. Cl. CPC G06Q 30/0645; G06F 17/30345

(57) ABSTRACT

The present invention generally relates renting self-storage. Specifically the system provides a way to manage transactions and facilitate the use of distributed storage space that is available in varying amounts in houses, attics, lofts, garages, closets, offices, and crawl spaces, etc. in the surrounding region. A coordinating server connects storage clients with storage providers who can meet their storage needs, tracks containers, sends notifications, and manages requests for transfer of containers.

### FIELD OF THE INVENTION

The present invention generally relates to the rental of self-storage space. Specifically, embodiments of the present invention disclose a system of providing storage space to clients by using the spare storage space available in houses, attics, lofts, garages, closets, and offices, etc. distributed throughout the surrounding region and facilitating the connection between clients and storage providers with various quantities of spare storage space.

### BACKGROUND OF THE INVENTION

Traditional self-storage services are typically provided by building a facility with various sized rooms dedicated solely to the purpose of storage. These rooms are rented out to clients with storage needs. Any room that is not rented out sits unused. Similarly, any space that the client fails to fill sits unused. In addition, although a client may rent multiple rooms, any given room is typically rented to just one client. The storage provider does not rent half the room to one client and the other half to a different client. A client can split the fee and the space with a friend, but there is no generally applicable way for a client to rent the exact number of cubic feet required. The obvious inefficiencies of this system are only a small part of the overall inefficiency inherent in the act of using valuable real estate to build a facility dedicated solely to the purpose of storage. The only real requirement for a space to be suitable for storage is that it is not being used for something else. In many circumstances, the spare space gathering dust in houses, attics, lofts, garages, closets, offices, and crawl spaces, etc. distributed around a region is not just suitable, but ideal for storing physical property. The inherent problem is that people who need extra storage space necessarily don't have it, and those that have extra storage space obviously don't need it. There is plenty of space available, but the process of finding and using it is usually more trouble than it's worth. It's often just so much easier to go to the local self-storage facility and rent a room that's just a little bigger than what you really need.

Modern information technology provides a way to dramatically reduce the transaction cost of finding and using distributed storage space. The present invention leverages social interactions, network communications, and automated information management to create a system and method that efficiently connects those who need storage space with people nearby who have storage space. These and other features and advantages of the present invention will be explained and will become obvious to one skilled in the art through the summary of the invention that follows.

### SUMMARY OF THE INVENTION

Accordingly, it is an object of the present invention to provide a system and method configured to dramatically reduce the transportation cost of finding and using distributed storage space.

According to an embodiment of the present invention, a computer implemented method of tracking and managing a distributed peer storage system includes the steps of: receiving a request from a storage client to store a container; assigning the container a unique identifier; updating the database to indicate that the container belongs to the storage client; updating a database to indicate that the container was checked in at a temporary holding facility; sending a notification to a storage provider that the container is to be checked out; updating the database to indicate that the container was checked out of the temporary holding facility; updating the database to indicate that the container is stored with the storage provider.

According to an embodiment of the present invention, a computer implemented method wherein the container is a secured container provided to the storage client.

According to an embodiment of the present invention, a computer implemented method wherein the secured container has a tamper evident seal.

According to an embodiment of the present invention, a computer implemented method wherein the storage provider is a commercial storage provider.

According to an embodiment of the present invention, a computer implemented method wherein the storage provider is a person who has spare space for storage.

According to an embodiment of the present invention, a computer implemented method of tracking and managing a distributed peer storage system includes the steps of: receiving a request from a storage client to retrieve a container; sending a notification to a storage provider that the container should be moved to a temporary holding facility; updating the database to indicate that the container was checked in at the temporary holding facility; sending a notification to the storage client that the container can be picked up; updating the database to indicate that the container was checked out at the temporary holding facility;

According to an embodiment of the present invention, a system for tracking and managing a distributed peer storage system includes: a computer implemented interface module for collecting storage information over a network connection, the storage information comprising: a) information about a storage client, b) information about the dimensions of one or more containers to be stored, c) information about one or more storage providers, and d) information about the dimensions of a storage space which the storage providers will provide for storage purposes; a computer implemented matching module for calculating matching results, wherein the matching results comprise information matching the containers with the storage space; a computer implemented database module for storing the storage information and the matching results; a computer implemented communication module for sending notifications to the storage clients and the storage providers.

According to an embodiment of the present invention, the system further includes a temporary holding facility.

According to an embodiment of the present invention, the system further comprises secured containers which are provided to the storage clients.

According to an embodiment of the present invention, the secured container has a tamper evident seal.

According to an embodiment of the present invention, the system further comprises an exchange module for facilitating and/or scheduling the exchange of the containers between the storage client and the storage provider.

According to an embodiment of the present invention, the system further comprises a pickup and/or delivery service.

According to an embodiment of the present invention, the pickup and/or delivery service is performed by at least one of: a) An autonomous vehicle and b) A remote controlled vehicle.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a high level diagram of the interactions between the storage client, storage provider, and coordination server;

FIG. 2 is a detailed diagram the various subparts of the coordination server and their communication with each other and the outside world;

FIG. 3 is a high level diagram of the temporary holding facility with check-in and check-out procedures for completing the exchange of one or more containers between the storage client and storage provider;

FIG. 4 is a flowchart showing the operation of the matching module in the coordination server, where the matching module generates a list of storage providers, each of which can individually meet the needs of the storage client;

FIG. 5 is a flowchart showing the operation of the matching module in the coordination server, where the matching module generates a list of one or more storage providers, which taken together, collectively meet the needs of the storage client.

### DETAILED SPECIFICATION

The present invention generally relates to the rental of self-storage space. Specifically, embodiments of the present invention disclose a system of providing storage space to clients by using the spare storage space available in houses, attics, lofts, garages, closets, offices, and crawl spaces, etc. in the surrounding region and facilitating the connection between clients and storage providers with various quantities of spare storage space.

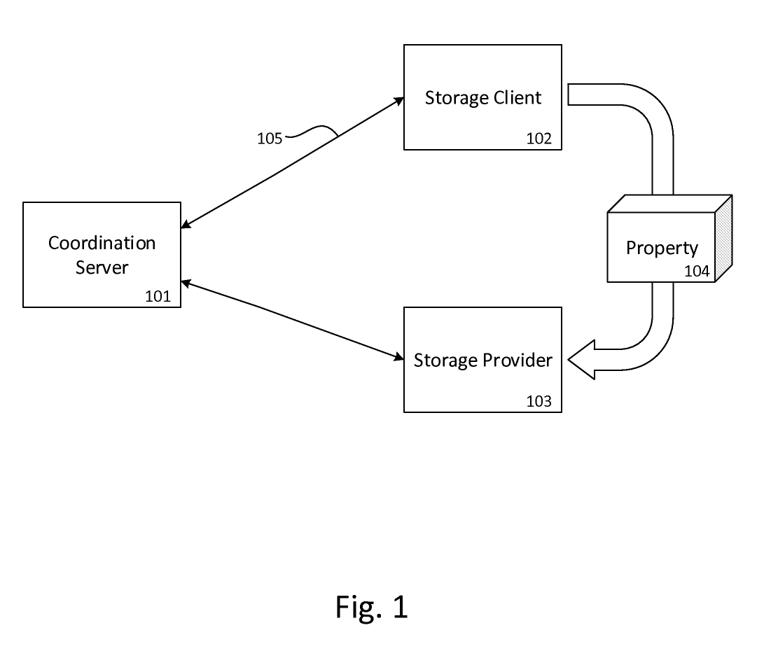

According to an embodiment of the present invention, FIG. 1 illustrates the process of storing physical property 104 through the present invention. Physical property 104 comprises one or more containers filled with whatever it is the storage client wants to store, or items which are self-contained, or require no container, such as a safe, a piano, a vehicle, or furniture, etc. Each container or item is assigned a unique identifier to allow it to be tracked by a coordination server 101, and identified by human beings. A coordination server 101 is set up to communicate over network connections 105 with users. The term users comprises storage clients 102, storage providers 103, or administrators of the distributed storage management system. A storage client 102 is identified by name, contact information, user ID, or customer number. A storage client 102 may be anybody with storage needs and a storage provider 103 may be anybody with storage space.

The coordinating server 101 gets necessary information from the storage clients 102 and storage providers 103 and determines, who among many storage providers 103, can meet the needs of the storage client 102 at maximum convenience to the parties involved. Once the coordination server 101 has determined how to meet the storage needs of the clients, it facilitates the exchange of physical property 104 between the storage client 102 and the storage provider 103. The simplest way to facilitate the exchange of physical property 104 is to provide a way for the storage client 102 and storage provider 103 to contact each other, and leave it to them to make the appropriate arrangements and consummate the transaction. Contact can be initiated through giving both parties the email, phone, or contact information of the other, or by providing a web or application interface where they can exchange messages with each other, or by any other method that fits the communication and privacy preferences of the parties.

According to an embodiment of the present invention, one or more secure containers are provided to the storage client 102. Each of these containers is assigned a unique identifier which is visible on the outside of the container and entered into the coordination server 101 for tracking. These containers may all have identical length, width, and height dimensions or they may have varying dimensions. These containers may be secured with a tamper evident-seal or sticker, or may have an electronic detection system for detecting unauthorized access to the container. These containers can be chosen from a set of a fixed number of varying container sizes to simplify storage and management of the containers. Unsecured containers may also be used with the present invention and the term container in this specification may refer to both secured and unsecured containers either provided to the storage client, or provided by the storage client.

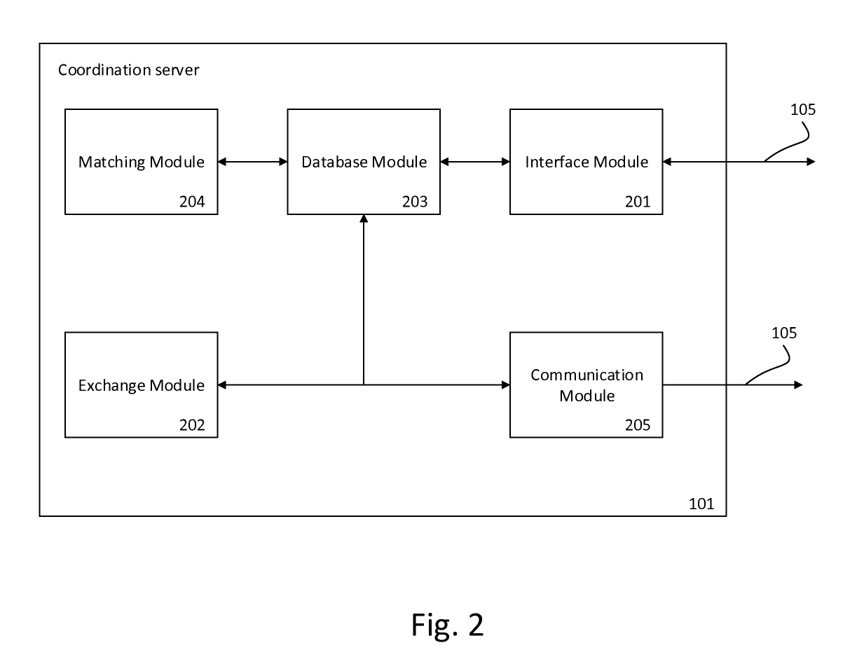

Referring now to FIG. 2, there are three primary functions of the coordinating server 101. The first function is to interact with storage clients 102 and storage providers 103 to obtain necessary details of their storage needs and capabilities respectively. This is done over a network connection 105 through the interface module 201. For example, the interface module 201 collects the location of the storage client 102, the number of containers to be stored, the specific dimensions of each container, and any specific requirements or preferences of the storage client 102 such as climate control, cold storage, dry storage, incompatibility with other storage items, or short notice availability. With regard to storage providers 103, the coordination server 101 collects information about the location of the storage provider 103, what storage spaces are available, the volume and dimensions of those spaces, and other unique characteristics, such as whether the space is outdoors, climate controlled, or monitored by a security system. The information gathered from the storage client 102 and storage provider 103 is stored in the database module 203. Location is a particularly useful piece of information because the closer a storage client 102 and storage provider 103 are to each other, the more convenient it is for them to make a transaction with each other.

The second function of the coordinating server 101 is to match up the needs of a storage client 102 with space available from one or more storage providers 103. The matching module uses data stored in the database module 203 and stores results in the database module 203. There are a variety of ways in which the matching module 204 can find storage providers 103 which meet the needs of the storage client 102 depending on the particular situation and preferences of the storage client 102. These matching methods will be explained in more detail later in the specification.

The third function of the coordinating server is to facilitate the actual exchange of physical property 104 between the storage client 102 and storage providers 103. This includes both the action of storing physical property 104 and retrieving physical property 104 from storage. The exchange module 202 handles this task. According to one embodiment of the present invention, the storage client 102 exchanges physical property 104 directly with the storage provider 103. As explained above, the simplest way to facilitate this exchange is to provide a way for the storage client 102 and storage provider 103 to contact each other, and leave it to them to make the appropriate arrangements and consummate the transaction. However, another method of facilitating the exchange is to provide a scheduling service which automatically suggests to the storage provider 103 and storage client 102 a time and place for the exchange based on the schedules disclosed by the two parties. Another option is to provide a pickup service which will send a car, truck, van, remote control drone, or autonomous Unmanned Aerial Vehicle (UAV) to transport the physical property 104. In any case, the exchange module 202 handles the scheduling and facilitation of pick-up, drop-off, and general exchange of physical property 104. One of ordinary skill in the art would recognize there are a variety of ways to transport physical property 104 between the storage client 102 and the storage provider.

The communication module 205 handles sending notifications to the storage client 102 and storage provider 103. These notifications my let the storage provider know that a container has been requested or that a new container is ready to be picked up. Notification can also be used to alert the storage client that a container requested is available for pickup at a temporary holding facility, or that a container is being moved to another location or switching storage providers. Notifications can also server to alert users to payments due, payments posted, and update users about recent positive or negative reviews that have been placed about them or somebody they have had a transaction with in the past. According to one embodiment of the present invention, the communication module also handles text, app-based, or wearable device interactions between the users and the coordination server, and also updates received regarding the containers themselves, their status, or location during transit, etc.

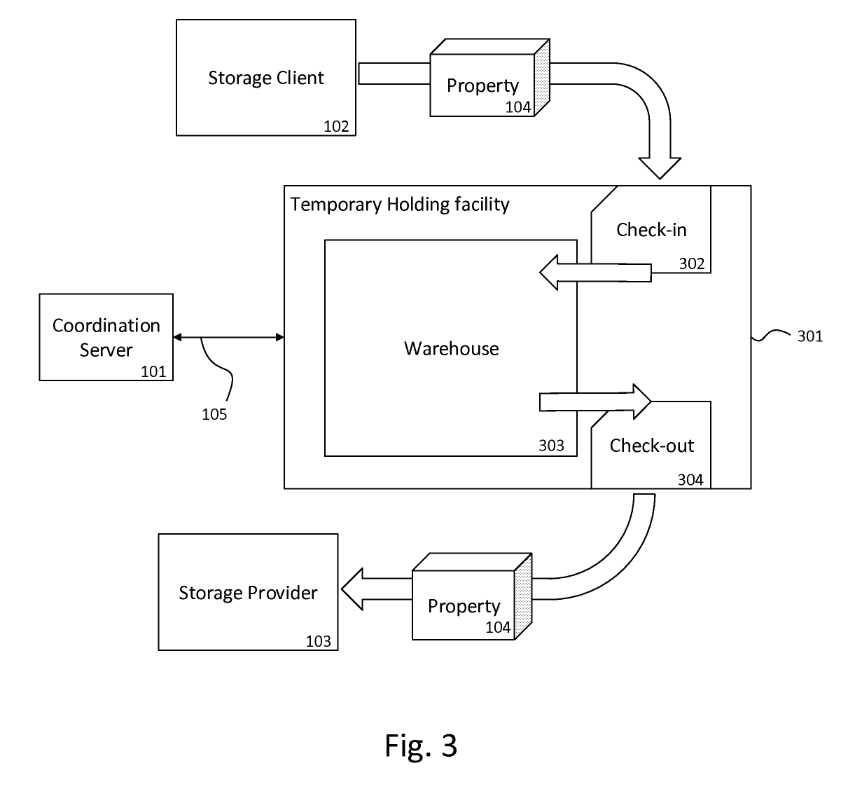

According to one embodiment of the present invention, FIG. 3 shows a diagram of a temporary holding facility 301, which acts as an intermediate point between the storage client 102 and the storage provider 103. The purpose of the temporary holding facility 301 is to store physical property 104 short term so that storage clients 102 and storage providers 103 may drop off and pick up physical property 104 at their leisure without having to find a mutually agreeable time and place for an exchange, and to allow multiple storage providers 103 to collectively meet the needs of a storage client 102 without the storage client 102 arranging multiple separate exchanges with each individual storage provider 103. The temporary holding facility 301 receives physical property 104 through a check-in 302 process 302, where each container is assigned a unique identifier. The unique identifier can also be assigned to each container before arrival at the temporary holding facility 301. This unique identifier is used by the coordination server 101 to track the location of each container. When the check-in 302 process is complete, the coordination server 101 sends a notification to the storage providers 103 who will store the physical property 104. During the time between check-in 302 and check-out 304, the physical property 104 is stored temporarily in a warehouse 303. The storage providers 103 pick up the physical property 104 from the temporary holding facility 301 though a check-out 304 process 304, which comprises updating the coordination server 101 with a new status indicating the physical property 104 has left the temporary holding facility 301 and been received by the storage provider 103. When a temporary holding facility 301 is used, the storage client 102 need not know who the storage provider 103 is and the needs of the storage client 102 can be conveniently met through multiple independent storage providers 103.

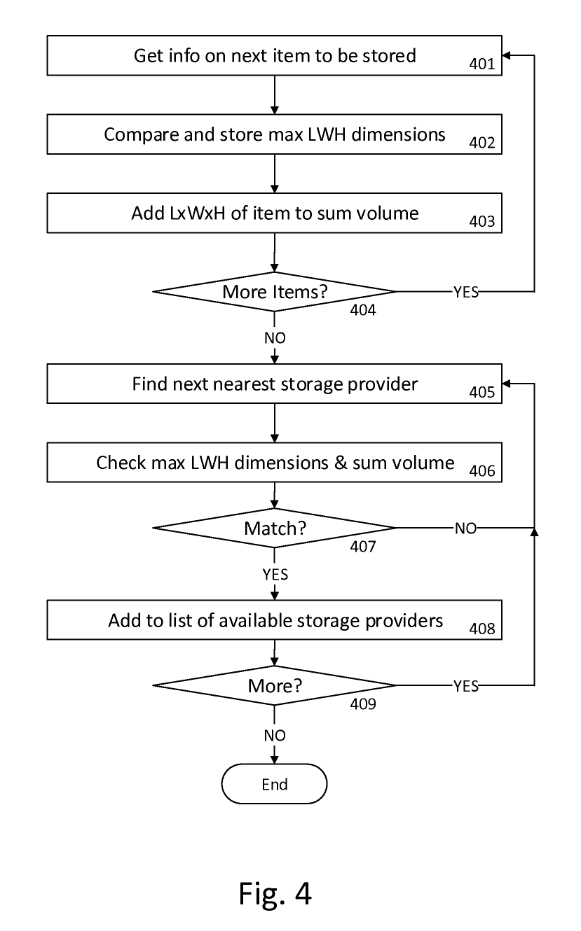

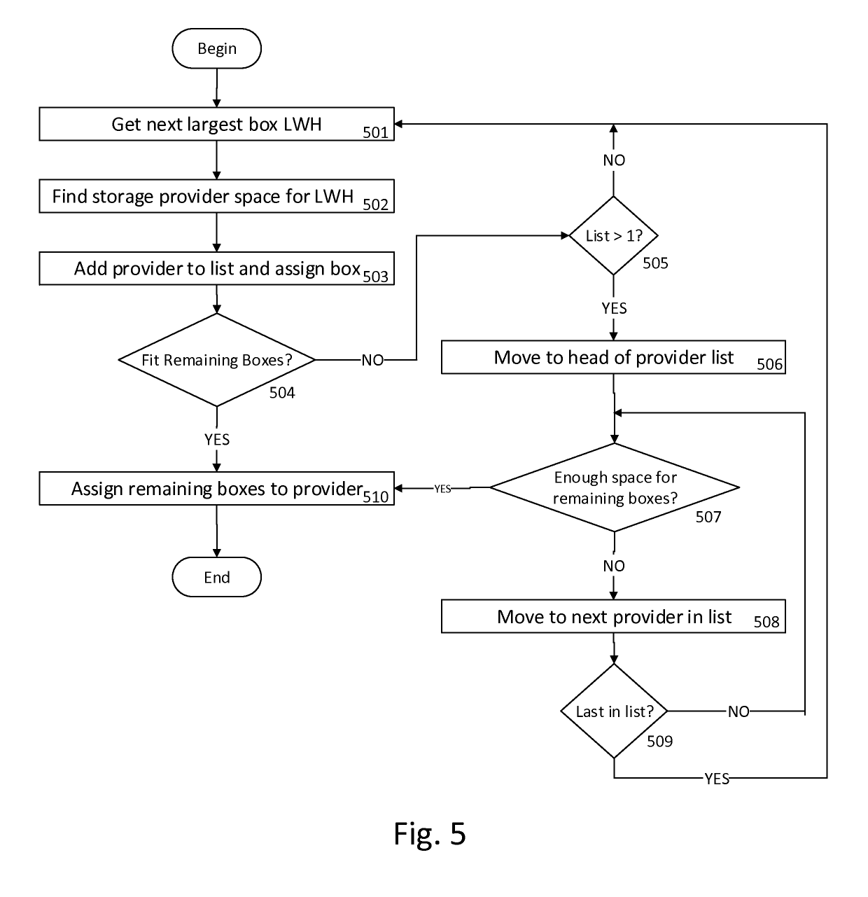

According to one embodiment of the present invention, the storage client 102 exchanges physical property 104 directly with the storage provider 103, so it is desirable for the storage client 102 to use only one storage provider 103. This reduces the complexity of transporting and exchanging physical property 104 between the storage client 102 and the storage provider 103. Therefore, in this situation, the matching module 204 will find the nearest storage provider 103 that is capable of storing everything the storage client 102 needs to store in a particular transaction. The matching module 204 stores its results in the database module 203. In the following examples and embodiments detailed in FIG. 4 and FIG. 5, the term container is used for illustrative purposes only. The algorithms described below apply equally to self-contained items and items which require no container.

FIG. 4 shows a flowchart of one process of the matching module 204 for generating a list of suitable storage providers 103, each of whom can independently meet the needs of the storage client 102 for a particular transaction. At the first step 401 in the process of FIG. 4, the interface module 201 has already collected the data on each container that the storage client 102 needs to store, and there are a number of storage providers 103 who have submitted their storage capabilities to the coordination server 101. In step 401, the matching module 204 retrieves the information about the first container that needs to be stored; this includes, but is not limited to, length, width and height (LWH) dimensions, weight and any special requirements (cold storage, low humidity, etc.) for the container. In order to be able to store the physical property 104, a storage provider 103 must have space with dimensions at least as big as the largest dimensions found among all the containers that need to be stored. So, in step 402, the matching module 204 keeps track of the largest dimensions found so far. Then in step 403, the matching module 204 calculates the total volume of the container and adds it to a running sum of the total volume. If there are more items, step 404, the matching module 204 then proceeds back to step 401, retrieves the information about the next container and repeats steps 401 through 404 until all containers have been processed.

The total volume at this point represents the minimum amount of storage space needed to store the containers, but multiple containers cannot usually be packed 100% efficiently. The matching module 204 compensates for this by multiplying the total volume by a packing factor. The packing factor is a number greater than or equal to 1 which represents how much more space is needed than the sum volume of all containers in order to store them. For one container, the default packing factor is 1, as long as the maximum dimension requirements are satisfied. For multiple containers of identical dimensions, the packing factor is 1.5 by default. For multiple containers of varying dimensions, the packing factor defaults to 2. These are fairly generous numbers which should account for the fact that most people aren't very good at 3D Tetris and will need considerably more space than the absolute minimum requirement. According to one embodiment of the present invention, storage clients 102 may set a custom packing factor to whatever number they like.

Referring again to FIG. 4, once the total volume of space required is calculated, including the packing factor, the matching module 204 turns to finding all suitable storage providers 104 that fit the max dimensions and volume requirements. Step 405 gets information on the next nearest storage provider 103. In step 406, the matching module 204 checks to see if the storage provider 103 can accommodate the maximum LWH dimensions and volume required. If there is a match, step 407, the storage provider 103 is added to a list of storage providers 103. Step 409 returns the matching module 204 to step 405 if there are more storage providers 103 to check, and steps 405 through 409 are repeated until all storage providers 103 have been checked. Because there may be a large number of possible storage providers 103, the matching module 204 may optionally look at only those within a certain distance of a location provided by the storage client 102, or use other filtering rules. These other filtering rules may include, but are not limited to storage options such as cold storage, low humidity, or climate controlled, etc.

The packing factor explained above need to be a rigid limit on our ability to assign containers to storage providers 104. The purpose of the packing factor is to provide a cushion for error. Therefore, when the matching module 204 is assigning containers to a storage provider 104 and the volume requirement is only exceeded by a small amount (ex. 5-10%), the matching module 204 will assign the containers to the storage provider anyway because the packing factor provides a significant margin for error.

Once a list of suitable storage providers 103 is produced as shown in FIG. 4, the interface module 201 then provides the storage client 102 with a choice of which storage provider 103 to use. Since storage providers 103 are individuals who are not necessarily professionals, some additional information is useful in helping the storage client 102 make a decision on where to store his physical property 104. Therefore, the user is provided with ratings and reviews of each storage provider 103 generated by other users of the community. These reviews produce a reputation for each storage provider 103 so that storage clients 102 can be made aware of storage providers 103 who excel or fail at providing adequate services.

There are a variety of ways to present the storage client with a list of suitable storage providers 103. According to one embodiment of the present invention, a web interface presents a graphical user interface (GUI) which shows an image of the storage provider 103 along with location, distance, a rating, snippets taken from user reviews, green check marks next to available special storage options and red Xs next to unavailable special storage options, a button that allows the storage client 102 to view more detailed information, and a button that allows the storage client 102 to choose the storage provider. According to an embodiment of the present invention, a storage client 102 may be a repeat user. If so, the system can recommend using the same storage provider 103 the client previously used.

According to an embodiment of the present invention, the storage client 102 uses a temporary holding facility 301 as an intermediate point between the storage client 102 and the storage provider 103. The storage client 102 drops off his physical property 104 at the temporary holding facility 301, and a storage provider 103 later comes and picks the physical property 104 up. The storage client 102 need not know who the storage provider 103 is and the needs of the storage client 102 can be met through a plurality of independent storage providers 103. In this situation, the matching module 204 will find one or more storage providers 103 which collectively meet the needs of the storage client 102. This function of the matching module 204 need not be limited to the physical property 104 of a single storage client 103. However, for illustration purposes, we will use an example of storing multiple containers belonging to a single client.

FIG. 5 shows a flowchart of the process which the matching module 204 uses to find multiple storage providers that can collectively meet the needs of the storage client 102. In step 501, the matching module 204 gets the LWH dimensions of the next container. If the process has just begun, this is the first container. The container for which a storage place is currently being searched is referred to as the current container. The first time through step 502, there will be no list of storage providers yet, so we skip to step 507 and find a suitable storage provider in the database module 203 that can fit the LWH dimensions of the current container. Once a suitable storage provider 103 is found, it is added to the list of providers in step 508, and the current container is assigned to that storage provider 103 in step 509. The matching module 204 then checks if there are more containers in step 510. When there are more containers to store, we go back to step 501 and get the next container.

When step 502 finds that there are already storage providers 104 in the list, we move to the beginning of the provider list in step 503. Step 504 checks if the current container will fit with the current storage provider 104, taking into account other containers that are already assigned to the storage provider 104. If the container will fit, we skip to step 509 where the current container is assigned to the current storage provider 104. Otherwise, we check to see if the current storage provider 104 is the last in our provider list in step 505. If we have not reached the end of the provider list, step 506 moves to the next provider in the provider list and we return to step 504, repeating steps 504-506 until the entire provider list has been checked for space to store the current container. When we reach the end of the provider list in step 505 without finding a space to store the current container, we move to step 507 and find a new suitable storage provider 104 in the database module 203, then add the new storage provider 104 to the provider list in step 508, and assign the current container to the new storage provider 104 in step 509. When there are no more containers to be assigned, the process ends.

One way to reduce the number of storage providers 104 required to store a set of containers is to start by finding space for the biggest container first, and continue in descending order of size until space for all containers has been found. If maximum packing efficiency is desired, there are mathematical algorithms for finding the best way to pack multiple containers with varying dimensions into a space with given dimensions.

According to an embodiment of the present invention, the matching module 204 can be greatly simplified. In most cases, suitable storage can be found simply by checking the max LWH dimensions and volume to make sure the containers will fit in the storage space disclosed by the storage provider. The storage provider is provided the opportunity to accept or reject the opportunity to store a container if he doesn't believe he can or doesn't want to store it. The requirement to return the container at his own expense if he later changes his mind should be sufficient incentive to encourage the storage provider to be accurate and reasonable about how much he claims he is capable of storing.

Although one embodiment of the present invention provides storage space to individuals and obtains storage space from individuals, there is nothing to keep it from being adapted for use by a commercial storage provider 103 to rent out excess storage space or outsource the fulfillment of storage requests to other facilities or individuals.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method of tracking and managing a distributed peer storage system comprising:
receiving a request from a storage client to store a container;
assigning said container a unique identifier;
updating said database to indicate that said container belongs to said storage client;
updating a database to indicate that said container was checked in at a temporary holding facility;
sending a notification to a storage provider that said container is to be checked out;
updating said database to indicate that said container was checked out of said temporary holding facility;
updating said database to indicate that said container is stored with said storage provider.

2. The method of claim 1 wherein said container is a secured container provided to said storage client.

3. The method of claim 2 wherein said secured container has a tamper evident seal.

4. The method of claim 1 wherein said storage provider is a commercial storage provider.

5. The method of claim 1 wherein said storage provider is a person who has spare space for storage.

6. A computer implemented method of tracking and managing a distributed peer storage system comprising:
receiving a request from a storage client to retrieve a container;
sending a notification to a storage provider that said container should be moved to a temporary holding facility;
updating said database to indicate that said container was checked in at said temporary holding facility;
sending a notification to said storage client that said container can be picked up;
updating said database to indicate that said container was checked out at said temporary holding facility;

7. A system for tracking and managing a distributed peer storage system comprising:
A computer implemented interface module for collecting storage information over a network connection, said storage information comprising:
a) information about a storage client,
b) information about the dimensions of one or more containers to be stored,
c) information about one or more storage providers, and
d) information about the dimensions of a storage space which said storage providers will provide for storage purposes;
a computer implemented matching module for calculating matching results, wherein said matching results comprise information matching said containers with said storage space;
a computer implemented database module for storing said storage information and said matching results;
a computer implemented communication module for sending notifications to said storage clients and said storage providers.

8. The system of claim 7 further comprising a temporary holding facility.

9. The system of claim 7 further comprising one or more secured containers which are provided to said storage client.

10. The system of claim 9 wherein said secured container has a tamper evident seal.

11. The system of claim 7 further comprising an exchange module for facilitating and/or scheduling the exchange of said containers between said storage client and said storage provider.

12. The system of claim 7 further comprising a pickup and/or delivery service.

13. The system of claim 11 wherein said pickup and/or delivery service is performed by at least one of:
a) An autonomous vehicle, and
b) A remote controlled vehicle.
